(19) United States
(12) Patent Application Publication
(10) Pub. No.: US 2021/0109785 A1
(43) Pub. Date: Apr. 15, 2021

(54) METHODS, SYSTEMS, ARTICLES OF MANUFACTURE AND APPARATUS TO BATCH FUNCTIONS

(71) Applicant: Intel Corporation, Santa Clara, CA (US)

(72) Inventors: Suraj Prabhakaran, Aachen (DE); Francesc Guim Bernat, Barcelona (ES)

(21) Appl. No.: 17/132,642

(22) Filed: Dec. 23, 2020

(51) Int. Cl. G06F 9/48; G06F 9/54; G06F 11/30; G06F 11/07

(52) U.S. Cl. CPC G06F 9/4887; G06F 11/0757; G06F 11/3051; G06F 9/546

(57) ABSTRACT

Methods, apparatus, systems and articles of manufacture are disclosed to batch functions. An example apparatus includes a function evaluator to, in response to receiving a function request associated with a function and an input, flag the function for batching, a timing handler to determine a waiting threshold associated with the function, a queue handler to store the function, the input, and the waiting threshold in a queue, and a client interface to, in response to a time duration the function is stored in the queue satisfying the waiting threshold, send the function and the input to a client device to increase throughput to the client device.

### FIELD OF THE DISCLOSURE

This disclosure relates generally to function batching, and, more particularly, to methods, systems, articles of manufacture and apparatus to batch functions.

### BACKGROUND

In recent years, the use of Edge computing has increased. In Edge cloud platforms, Function as a Service (FaaS) provides serverless computing to execute modular pieces of code on the Edge. For example, a function can be executed in response to an event and/or request.

### BRIEF DESCRIPTION OF THE DRAWINGS

FIG. 1 illustrates an overview of an Edge cloud configuration for Edge computing.

FIG. 2 illustrates operational layers among endpoints, an Edge cloud, and cloud computing environments.

FIG. 3 illustrates an example approach for networking and services in an Edge computing system.

FIG. 4 illustrates deployment of a virtual Edge configuration in an Edge computing system operated among multiple Edge nodes and multiple tenants.

FIG. 5 illustrates various compute arrangements deploying containers in an Edge computing system.

FIG. 6 illustrates an example Function as a Service (FaaS) system to execute functions.

FIG. 7 illustrates an example FaaS pipeline architecture.

FIG. 8A is a block diagram of an example first Edge platform architecture constructed in accordance with teachings of this disclosure to batch functions.

FIG. 8B is a block diagram of an example second Edge platform architecture constructed in accordance with teachings of this disclosure to batch functions.

FIG. 9 illustrates an example function batching system.

FIG. 10 is a block diagram of an example function scheduling controller of FIGS. 8-9.

FIG. 11 is a flowchart representative of an example method that may be executed by the example function scheduling controller of FIGS. 8-10 to batch functions.

FIG. 12 is a flowchart representative of an example method that may be executed by the example function scheduling controller of FIGS. 8-10 to evaluate functions.

FIG. 13 is a block diagram of an example processing platform structured to execute the instructions of FIG. 3 and/or the example function scheduling controller of FIGS. 8-10.

FIG. 14 is a block diagram of an example software distribution platform to distribute software (e.g., software corresponding to the example computer readable instructions of FIGS. 11-12) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. In general, the same reference numbers will be used throughout the drawing(s) and accompanying written description to refer to the same or like parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein “substantially real time” refers to occurrence in a near instantaneous manner recognizing there may be real world delays for computing time, transmission, etc. Thus, unless otherwise specified, “substantially real time” refers to real time+/−1 second.

### DETAILED DESCRIPTION

Image processing in Edge cloud platforms include far Edge (e.g., street cabinets, poles, etc.) and/or near Edge (central offices, etc.). Image processing can be part of several workloads (e.g., use cases) at an Edge location, such as continuous video stream processing from statically installed cameras and video and image processing from user instantiated applications (e.g., for Augmented Reality (AR), for Virtual Reality (VR)).

One of the main paradigms considered for efficient use of Edge platforms is Function as a Service (FaaS). In the FaaS paradigm, an image processing function (e.g., an Artificial Intelligence (AI) face detection function, etc.) is invoked for a particular image (e.g., a frame from a video, etc.). In some examples, the image processing function is deployed in the platform in a container. Extensions to such FaaS frameworks can also be used to support accelerators, such as Field Programmable Gate Arrays (FPGAs), an accelerating having inference compute engine (ICE) units, etc.

However, in previous solutions, FaaS frameworks invoke one function for an image and/or frame, which limits computing performance (e.g., throughput, etc.). For example, in the case of accelerators, invoking one function at a time may not use the full potential of the accelerators. For example, an accelerator having 11 ICE units can perform inference for a set of 11 images at the same time. Thus, requesting one function per image through a container to the accelerator dilutes its computing performance potential. Batching of inputs can be performed at the software level by having separate batching functions. However, batching functions dedicate some essential core resources to the batching functions, which may be computationally expensive (e.g., in far Edge cases).

Some previous solutions have improved performance potential of FaaS in Edge computing. Previous solutions for batching are software-based. However, software-based solutions dedicate core resources to batching functions, which may negatively impact far Edge cases where service density needs to be high. The previous software-based solutions also increase software overhead, which may increase the latency of functions. Additionally, the previous software-based solutions may be complicated and/or infeasible when additional parameters (e.g., telemetry, etc.) are considered. For example, the previous software solutions may not be secure and/or meet security requirements of certain architectures.

In an Edge environment, some entity is responsible for batching to get the maximum performance. If the responsible entity is software (e.g., executing on a generic processor), the technique cannot take advantage of telemetry data in response to detecting a status and/or configuration of computing resources. To use the telemetry data, techniques need additional aspects, such as authentication and necessary application programming interfaces (API).

Examples disclosed herein remove and/or decrease the complexities of batching from previous software-based solutions. Examples disclosed herein set forth hardware level batching for FaaS frameworks. Example techniques disclosed herein include identifying a function for batching based on parameters such as the service level agreement (SLA), telemetry data, known parameters of the function execution, etc. Example techniques disclosed herein also include holding the identified function in a queue for a time duration to collect a batch of inputs. Thus, disclosed techniques wait for additional function requests to batch the inputs. Disclosed example techniques further include sending the identified function with a batch of inputs to an FaaS client for execution.

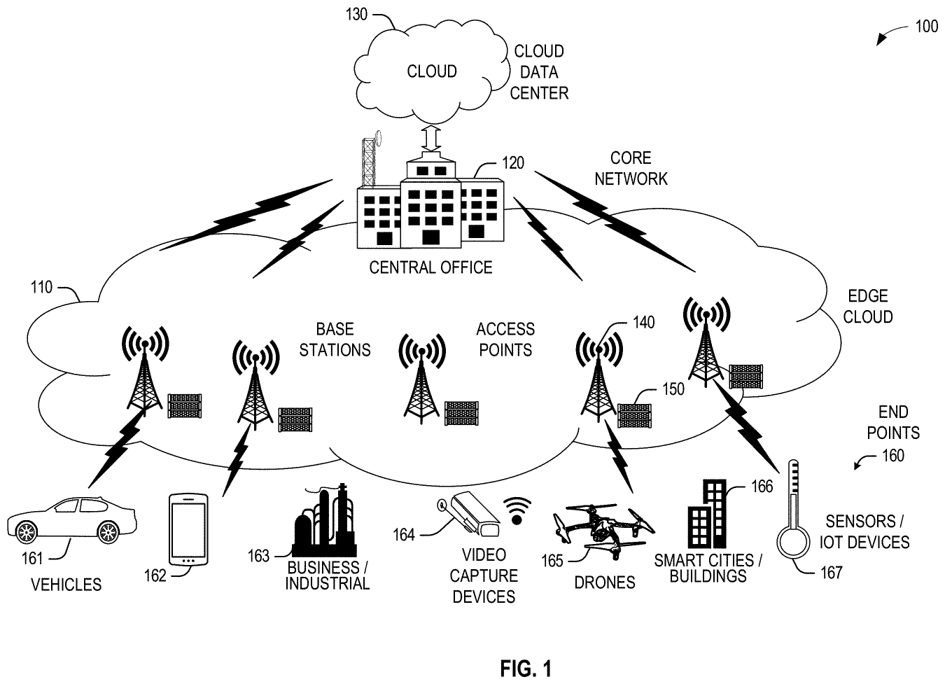

FIG. 1 is a block diagram 100 showing an overview of a configuration for Edge computing, which includes a layer of processing referred to in many of the following examples as an “Edge cloud”. As shown, the Edge cloud 110 is co-located at an Edge location, such as an access point or base station 140, a local processing hub 150, or a central office 120, and thus may include multiple entities, devices, and equipment instances. The Edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the Edge cloud 110 are critical to providing ultra-low latency response times for services and functions used by the endpoint data sources 160 as well as reduce network backhaul traffic from the Edge cloud 110 toward cloud data center 130 thus improving energy consumption and overall network usages among other benefits.

Compute, memory, and storage are scarce resources, and generally decrease depending on the Edge location (e.g., fewer processing resources being available at consumer endpoint devices, than at a base station, than at a central office). However, the closer that the Edge location is to the endpoint (e.g., user equipment (UE), customer-premises equipment (CPE), etc.), the more that space and power is often constrained. Thus, Edge computing attempts to reduce the amount of resources needed for network services, through the distribution of more resources which are located closer both geographically and in network access time. In this manner, Edge computing attempts to bring the compute resources to the workload data where appropriate, or, bring the workload data to the compute resources.

The following describes aspects of an Edge cloud architecture that covers multiple potential deployments and addresses restrictions that some network operators or service providers may have in their own infrastructures. These include, variation of configurations based on the Edge location (because edges at a base station level, for instance, may have more constrained performance and capabilities in a multi-tenant scenario); configurations based on the type of compute, memory, storage, fabric, acceleration, or like resources available to Edge locations, tiers of locations, or groups of locations; the service, security, and management and orchestration capabilities; and related objectives to achieve usability and performance of end services. These deployments may accomplish processing in network layers that may be considered as “near Edge”, “close Edge”, “local Edge”, “middle Edge”, or “far Edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within Edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

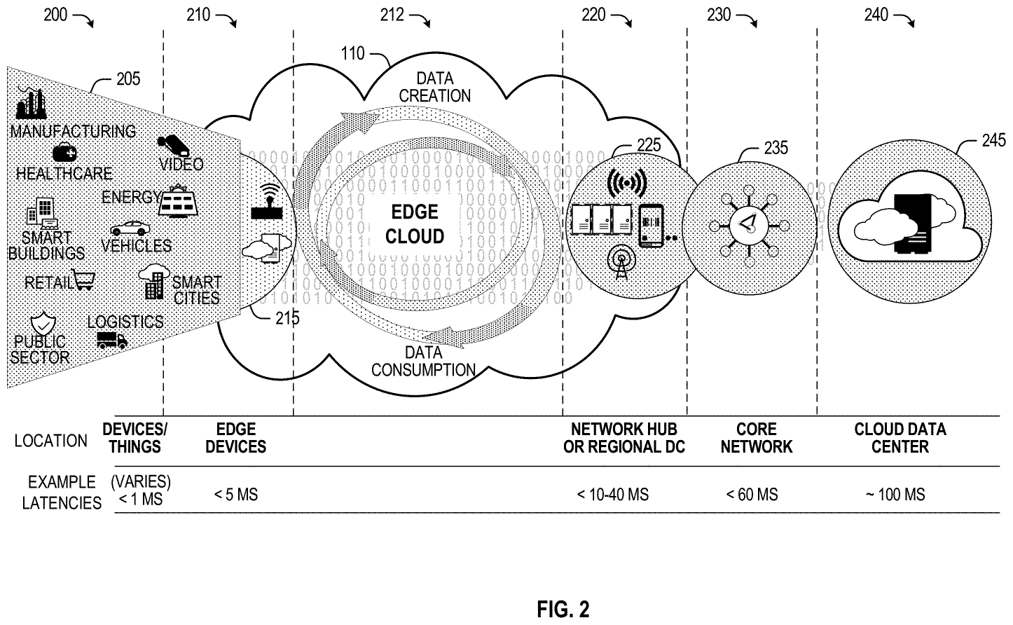

FIG. 2 illustrates operational layers among endpoints, an Edge cloud, and cloud computing environments. Specifically, FIG. 2 depicts examples of computational use cases 205, utilizing the Edge cloud 110 among multiple illustrative layers of network computing. The layers begin at an endpoint (devices and things) layer 200, which accesses the Edge cloud 110 to conduct data creation, analysis, and data consumption activities. The Edge cloud 110 may span multiple network layers, such as an Edge devices layer 210 having gateways, on-premise servers, or network equipment (nodes 215) located in physically proximate Edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the Edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the Edge devices layer 210, to even between 10 to 40 ms when communicating with nodes at the network access layer 220. Beyond the Edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close Edge”, “local Edge”, “near Edge”, “middle Edge”, or “far Edge” layers, relative to a network source and destination. For instance, from the perspective of the core network data center 235 or a cloud data center 245, a central office or content data network may be considered as being located within a “near Edge” layer (“near” to the cloud, having high latency values when communicating with the devices and endpoints of the use cases 205), whereas an access point, base station, on-premise server, or network gateway may be considered as located within a “far Edge” layer (“far” from the cloud, having low latency values when communicating with the devices and endpoints of the use cases 205). It will be understood that other categorizations of a particular network layer as constituting a “close”, “local”, “near”, “middle”, or “far” Edge may be based on latency, distance, number of network hops, or other measurable characteristics, as measured from a source in any of the network layers 200-240.

The various use cases 205 may access resources under usage pressure from incoming streams, due to multiple services utilizing the Edge cloud. To achieve results with low latency, the services executed within the Edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, Edge computing within the Edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of Edge computing comes the following caveats. The devices located at the Edge are often resource constrained and therefore there is pressure on usage of Edge resources. Typically, this is addressed through the pooling of memory and storage resources for use by multiple users (tenants) and devices. The Edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because Edge locations may be unmanned and may even need permissioned access (e.g., when housed in a third-party location). Such issues are magnified in the Edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an Edge computing system may be described to encompass any number of deployments at the previously discussed layers operating in the Edge cloud 110 (network layers 200-240), which provide coordination from client and distributed computing devices. One or more Edge gateway nodes, one or more Edge aggregation nodes, and one or more core data centers may be distributed across layers of the network to provide an implementation of the Edge computing system by or on behalf of a telecommunication service provider (“telco”, or “TSP”), internet-of-things service provider, cloud service provider (CSP), enterprise entity, or any other number of entities. Various implementations and configurations of the Edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the Edge computing system does not necessarily mean that such node or device operates in a client or agent/minion/follower role; rather, any of the nodes or devices in the Edge computing system refer to individual entities, nodes, or subsystems which include discrete or connected hardware or software configurations to facilitate or use the Edge cloud 110.

As such, the Edge cloud 110 is formed from network components and functional features operated by and within Edge gateway nodes, Edge aggregation nodes, or other Edge compute nodes among network layers 210-230. The Edge cloud 110 thus may be embodied as any type of network that provides Edge computing and/or storage resources which are proximately located to radio access network (RAN) capable endpoint devices (e.g., mobile computing devices, IoT devices, smart devices, etc.), which are discussed herein. In other words, the Edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the Edge cloud 110 may be servers, multi-tenant servers, appliance computing devices, and/or any other type of computing devices. For example, the Edge cloud 110 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, Edge devices are devices presented in the network for a specific purpose (e.g., a traffic light), but may have processing and/or other capacities that may be utilized for other purposes. Such Edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. The Edge cloud 110 may also include one or more servers and/or one or more multi-tenant servers. Such a server may include an operating system and a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

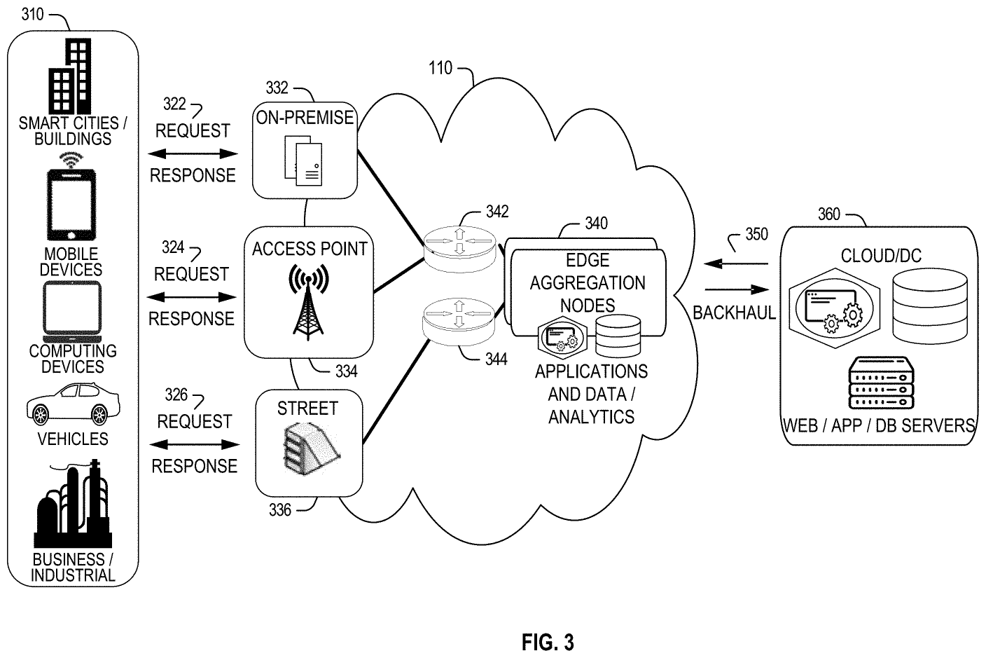

FIG. 3 illustrates an example approach for networking and services in an Edge computing system. In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the Edge cloud 110 to aggregate traffic and requests. Thus, within the Edge cloud 110, the TSP may deploy various compute and storage resources, such as at Edge aggregation nodes 340, to provide requested content. The Edge aggregation nodes 340 and other systems of the Edge cloud 110 are connected to a cloud or data center 360, which uses a backhaul network 350 to fulfill higher-latency requests from a cloud/data center for websites, applications, database servers, etc. Additional or consolidated instances of the Edge aggregation nodes 340 and the aggregation points 342, 344, including those deployed on a single server framework, may also be present within the Edge cloud 110 or other areas of the TSP infrastructure.

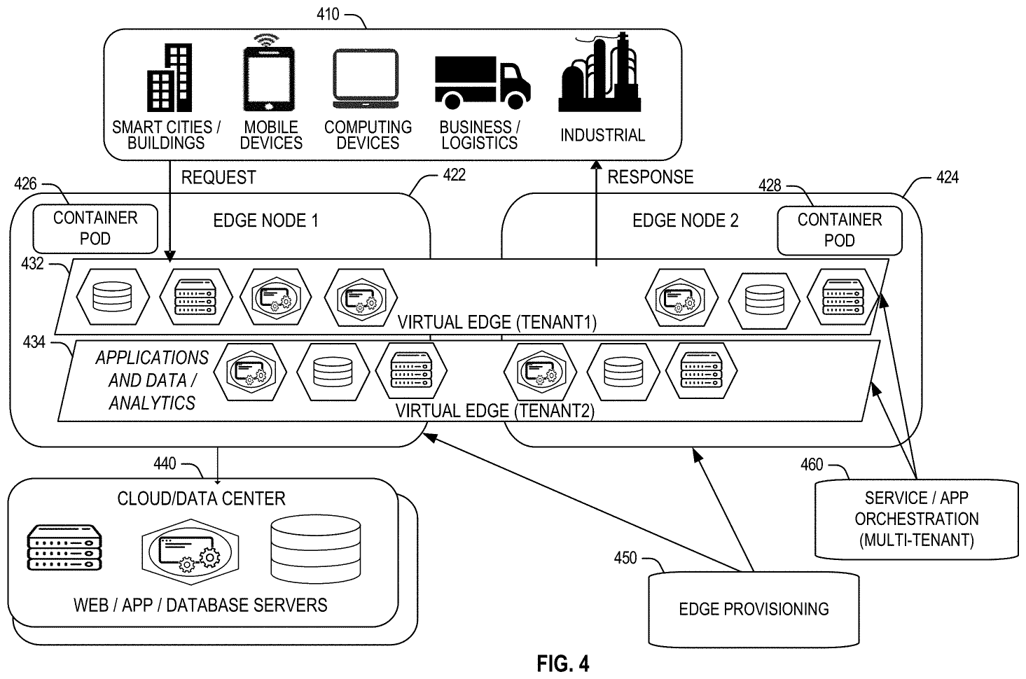

FIG. 4 illustrates deployment and orchestration for virtualized and container-based Edge configurations across an Edge computing system operated among multiple Edge nodes and multiple tenants (e.g., users, providers) which use such Edge nodes. Specifically, FIG. 4 depicts coordination of a first Edge node 422 and a second Edge node 424 in an Edge computing system 400, to fulfill requests and responses for various client endpoints 410 (e.g., smart cities/building systems, mobile devices, computing devices, business/logistics systems, industrial systems, etc.), which access various virtual Edge instances. Here, the virtual Edge instances 432, 434 provide Edge compute capabilities and processing in an Edge cloud, with access to a cloud/data center 440 for higher-latency requests for websites, applications, database servers, etc. However, the Edge cloud enables coordination of processing among multiple Edge nodes for multiple tenants or entities.

In the example of FIG. 4, these virtual Edge instances include: a first virtual Edge 432, offered to a first tenant (Tenant 1), which offers a first combination of Edge storage, computing, and services; and a second virtual Edge 434, offering a second combination of Edge storage, computing, and services. The virtual Edge instances 432, 434 are distributed among the Edge nodes 422, 424, and may include scenarios in which a request and response are fulfilled from the same or different Edge nodes. The configuration of the Edge nodes 422, 424 to operate in a distributed yet coordinated fashion occurs based on Edge provisioning functions 450. The functionality of the Edge nodes 422, 424 to provide coordinated operation for applications and services, among multiple tenants, occurs based on orchestration functions 460.

It should be understood that some of the devices in 410 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective Edge nodes 422, 424 may operate as security feature enforcement points for local resources allocated to multiple tenants per node. Additionally, tenant runtime and application execution (e.g., in instances 432, 434) may serve as an enforcement point for a security feature that creates a virtual Edge abstraction of resources spanning potentially multiple physical hosting platforms. Finally, the orchestration functions 460 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes often use containers, FaaS engines, Servlets, servers, or other computation abstraction that may be partitioned according to a DICE layering and fan-out structure to support a RoT context for each. Accordingly, the respective RoTs spanning devices 410, 422, and 440 may coordinate the establishment of a distributed trusted computing base (DTCB) such that a tenant-specific virtual trusted secure channel linking all elements end to end can be established.

Further, it will be understood that a container may have data or workload specific keys protecting its content from a previous Edge node. As part of migration of a container, a pod controller at a source Edge node may obtain a migration key from a target Edge node pod controller where the migration key is used to wrap the container-specific keys. When the container/pod is migrated to the target Edge node, the unwrapping key is exposed to the pod controller that then decrypts the wrapped keys. The keys may now be used to perform operations on container specific data. The migration functions may be gated by properly attested Edge nodes and pod managers (as described above).

In further examples, an Edge computing system is extended to provide for orchestration of multiple applications through the use of containers (a contained, deployable unit of software that provides code and needed dependencies) and/or virtualization in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an Edge computing system may be configured to fulfill requests and responses for various client endpoints from multiple virtual Edge instances (and, from a cloud or remote data center). The use of these virtual Edge instances may support multiple tenants and multiple applications (e.g., augmented reality (AR)/virtual reality (VR), enterprise applications, content delivery, gaming, compute offload) simultaneously. Further, there may be multiple types of applications within the virtual Edge instances (e.g., normal applications; latency sensitive applications; latency-critical applications; user plane applications; networking applications; etc.). The virtual Edge instances may also be spanned across systems of multiple owners at different geographic locations (or, respective computing systems and resources which are co-owned or co-managed by multiple owners).

For instance, each Edge node 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various Edge node resources (e.g., storage, compute, services, depicted with hexagons) provided for the respective Edge slices 432, 434 are partitioned according to the needs of each container.

With the use of container pods, a pod controller oversees the partitioning and allocation of containers and resources. The pod controller receives instructions from an orchestrator (e.g., orchestrator 460) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different Edge node that does satisfy it. Alternatively, the first pod may be allowed to execute and a different shared pod controller is installed and invoked prior to the second pod executing.

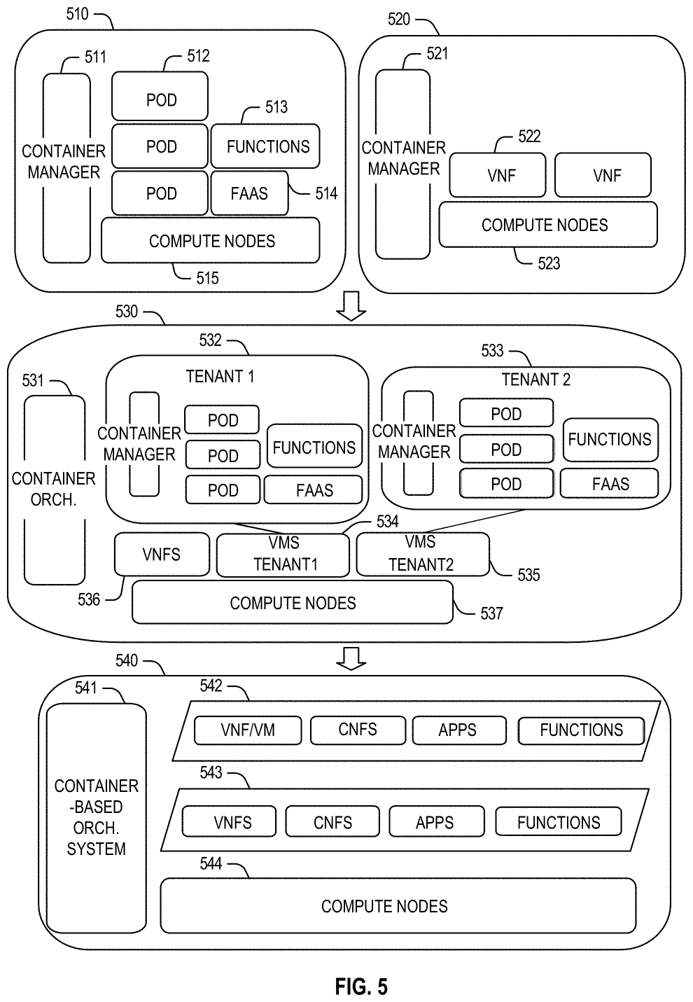

FIG. 5 illustrates additional compute arrangements deploying containers in an Edge computing system. As a simplified example, system arrangements 510, 520 depict settings in which a pod controller (e.g., container managers 511, 521, and container orchestrator 531) is adapted to launch containerized pods, functions, and functions-as-a-service instances through execution via compute nodes (515 in arrangement 510), or to separately execute containerized virtualized network functions through execution via compute nodes (523 in arrangement 520). This arrangement is adapted for use of multiple tenants in system arrangement 530 (using compute nodes 537), where containerized pods (e.g., pods 512), functions (e.g., functions 513, VNFs 522, 536), and functions-as-a-service instances (e.g., FaaS instance 514) are launched within virtual machines (e.g., VMs 534, 535 for tenants 532, 533) specific to respective tenants (aside the execution of virtualized network functions). This arrangement is further adapted for use in system arrangement 540, which provides containers 542, 543, or execution of the various functions, applications, and functions on compute nodes 544, as coordinated by a container-based orchestration system 541.

The system arrangements of depicted in FIG. 5 provides an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple Edge owners, coordinated by an orchestrator.

In the context of FIG. 5, the pod controller/container manager, container orchestrator, and individual nodes may provide a security enforcement point. However, tenant isolation may be orchestrated where the resources allocated to a tenant are distinct from resources allocated to a second tenant, but Edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves and hardware partitioning schemes may be used by Edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an Edge computing system. Software defined silicon (SDSi) may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

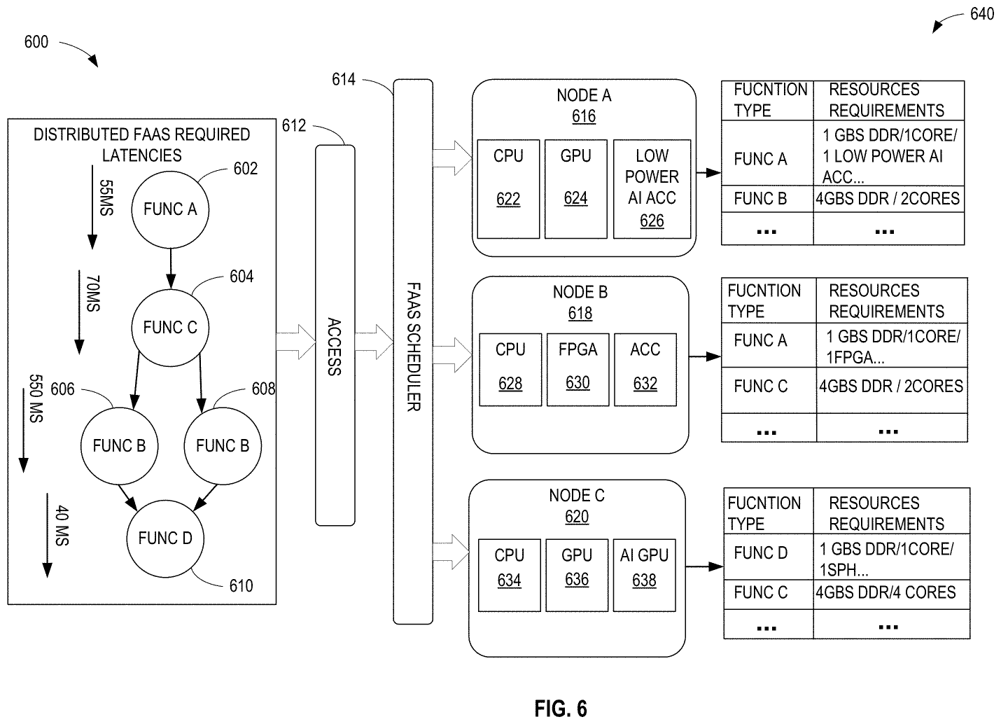

FIG. 6 illustrates an example FaaS system 600 to execute functions. The example FaaS system 600 includes an example function A request 602, an example function C request 604, an example first function B request 606, an example second function B request 608, and an example function D request 610. In some examples, the function A request 602 corresponds to decoding images, the function C request 604 corresponds to performing face detection, the function B requests 606, 608 correspond to performing face identification, etc. The function requests 602, 604, 606, 608, 610 are associated with latency requirements. In the illustrated example of FIG. 6, the function request A 602 has a latency requirement of 55 ms, the function C request 604 has a latency requirement of 70 ms, the function B requests 606, 608 have a latency requirement of 550 ms, and the function request D 610 has a latency requirement of 40 ms. That is, to comply with SLA requirements, the function request A 602 must be executed within 55 ms of the request, the function C request 604 must be executed within 70 ms of the request, etc.

In some examples, the FaaS system 600 is executed on an Edge platform. At block 612, the Edge platform accesses the function requests 602, 604, 606, 608, 610. The Edge platform includes an example FaaS scheduler 614. For example, the FaaS scheduler 614 accesses the function request 602, 604, 606, 608, 610 and sends the function requests to an example node A 616, an example node B 618, and/or an example node C 620. In the illustrated example of FIG. 6, the nodes 616, 618, 620 are computing nodes. For example, the node A 616 includes an example first CPU 622, an example first GPU 624, and an example low power AI accelerator 626. The example node B 618 includes an example second CPU 628, an example FPGA 630, and an example accelerator 632. The example node C 620 includes an example third CPU 634, an example second GPU 636, and an example AI GPU 638.

In the illustrated example of FIG. 6, the FaaS scheduler 614 sends the function requests 602, 604, 606, 608, 610 to the nodes 616, 618, 620 for execution based on example resource requirements 640 and the target hardware. For example, the function A request 602 has resource requirements of 1 GBS DDR, 1 core, and 1 low power AI accelerator, the function B request 606 has resource requirements of 4 GBS DDR and 2 cores, etc. The example FaaS scheduler 614 sends the function A request 602 and the first function B request 606 to the node A 616. That is, the example FaaS scheduler 614 sends the functions 602, 604, 606, 608, 610 to the nodes 616, 618, 620 based on the resource requirements 640 and the hardware of the nodes 616, 618, 620 (e.g., the CPU 622, the GPU 624, the low power AI accelerator 626, the CPU 628, etc.).

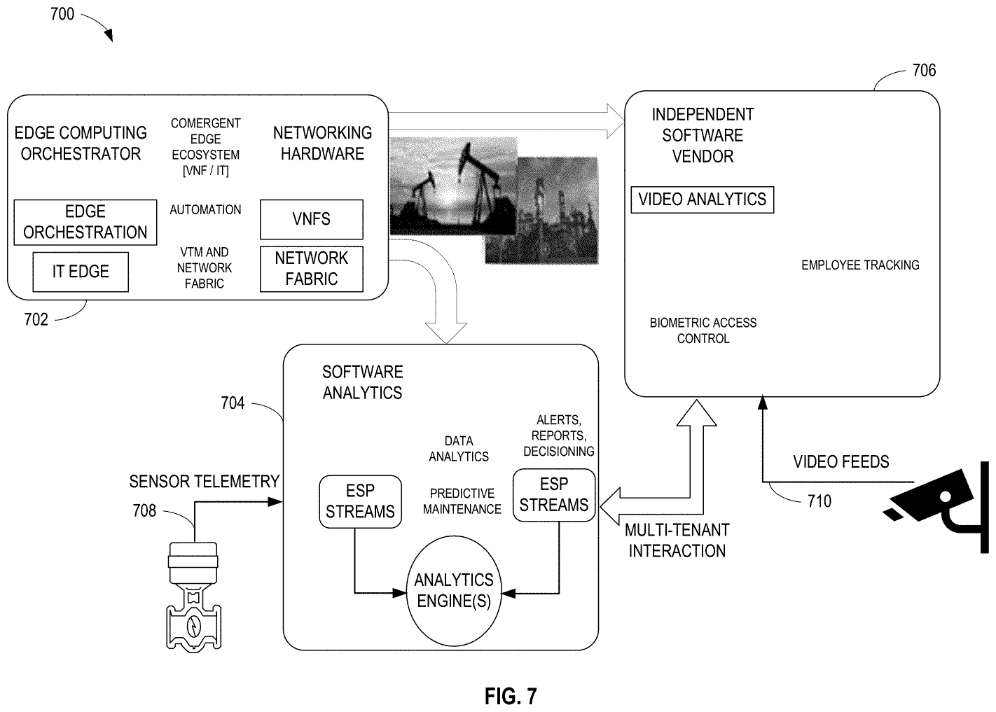

FIG. 7 illustrates an example FaaS pipeline architecture 700. The example FaaS pipeline architecture 700 includes an example first platform 702, an example second platform 704, and an example third platform 706. As used herein, a “platform” is a computing system having resources to accomplish computing tasks. Example resources may include particular processors, particular memory, particular bus configurations, particular input/output (I/O), particular accelerators, and the like. In some examples, the platforms 702, 704, 706 are operated by or otherwise managed by independent software vendors (ISVS). For example, the first platform 702 is a convergent Edge ecosystem. In some examples, the first platform 702 executes functions for automation, Edge orchestration, etc.

In the illustrated example of FIG. 7, the second platform 704 is a data analytic ecosystem. For example, the second platform 704 receives example sensor telemetry data 708 and executes functions for predictive maintenance, alerts, reports, decisioning, etc. on the sensor telemetry data 708. In the illustrated example of FIG. 7, the third platform 706 is a video analytics ecosystem. For example, the third platform 706 receives example video data 710 collected by an image sensor. In some examples, the third platform 706 executes functions for face detection, face identification, etc.

In some examples, the platforms 702, 704, 706 have different latency requirements, bandwidth requirements, etc. For example, the second platform 704 monitors the telemetry data 708 to generate safety alerts, and the third platform 706 analyzes the video data 710 to perform biometric analysis. In such examples, the second platform 704 may have relatively lower latency requirements compared to the third platform 706. Examples disclosed herein expose APIs of the platforms 702, 704, 706 to access latency requirements, etc. for batching logic disclosed herein. Thus, examples disclosed herein improve (e.g., reduce) the total cost of ownership (TCO) while maintaining the quality of service of the functions.

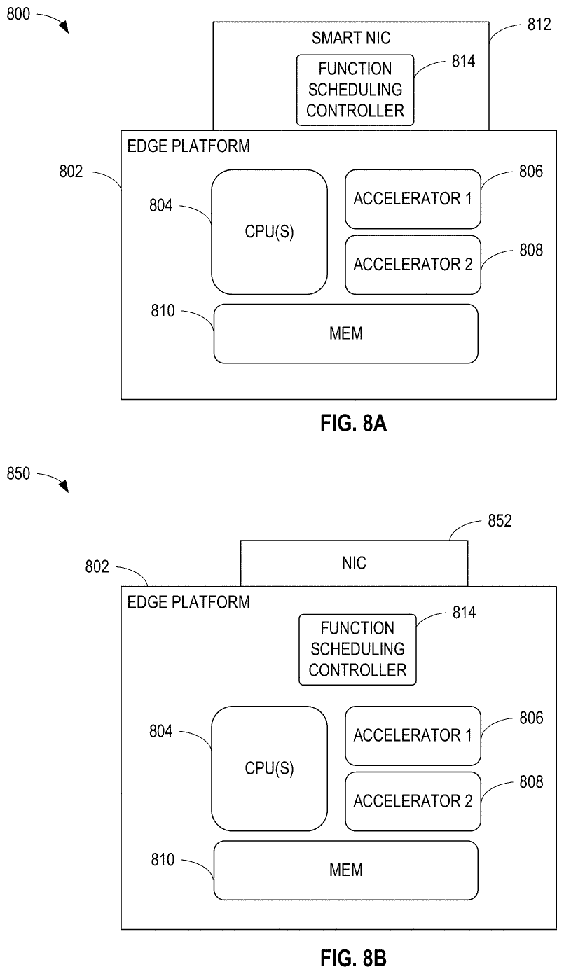

FIG. 8A is a block diagram of an example first Edge platform architecture 800 constructed in accordance with teachings of this disclosure to batch functions. The example first Edge platform architecture 800 includes an example Edge platform 802, example CPU(s) 804, an example first accelerator 806, an example second accelerator 808, and an example memory 810. In some examples, the Edge platform 802 is implemented in the example Edge cloud 110 of FIG. 1. For example, the Edge platform 802 receives and executes function requests (e.g., on the example CPU(s) 804, on the example accelerators 806, 808, etc.). In the illustrated example of FIG. 8A, the Edge platform 802 is communicatively connected to an example smart network interface card (NIC) 812. For example, the smart NIC 812 facilitates communication between the Edge platform 802 and external devices (e.g., the endpoints 160 of FIG. 1).

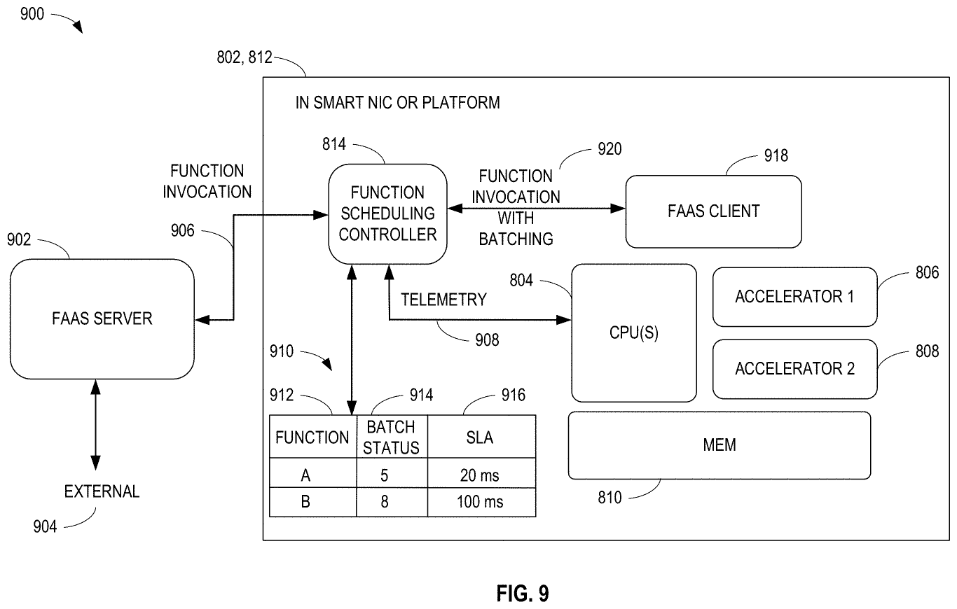

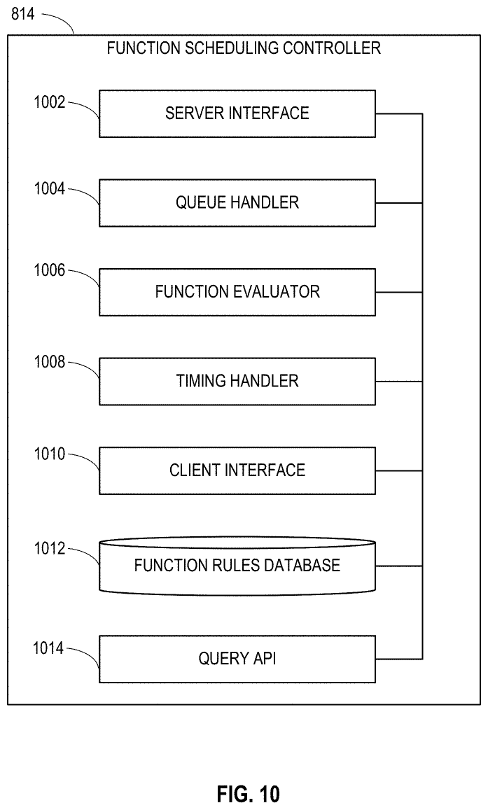

The smart NIC 812 includes an example function scheduling controller 814. The example function scheduling controller 814 receives and evaluates functions. That is, the function scheduling controller 814 determines whether functions can be held for a time duration to collect additional inputs (e.g., a batch of inputs). In some examples, the function scheduling controller 814 performs real-time scheduling of function batching. In response to determining a function can be batched, the function scheduling controller 814 determines a waiting threshold and stores the function in a queue for the waiting threshold. The function scheduling controller 814 sends the function and batch of inputs to a FaaS client for execution in response to the function being stored in the queue for the waiting threshold. That is, examples disclosed herein do not violate the SLA of functions (e.g., latency requirements, etc.). The example function scheduling controller 814 is described in further detail below in connection with FIGS. 9-10.

FIG. 8B is a block diagram of an example second Edge platform architecture 850 constructed in accordance with teachings of this disclosure to batch functions. The example second Edge platform 850 includes the example Edge platform 802, the example CPU(s) 804, the example first accelerator 806, the example second accelerator 808, and the example memory 810. In the illustrated example of FIG. 8B, the Edge platform 850 is communicatively coupled to an example NIC 852. For example, the NIC 852 facilitates communication between the Edge platform 802 and external devices. In contrast to the example first Edge platform architecture 800 of FIG. 8A, the example Edge platform 802 of the example second Edge platform architecture 850 includes the example function scheduling controller 814.

FIG. 9 illustrates an example function batching system 900. The example function batching system 900 includes an example FaaS server 902 and the example Edge platform 802 of FIG. 8 and/or the example smart NIC 812 of FIG. 8. The example FaaS server 902 receives input data and function requests from an example external device 904. For example, the external device 904 implements the end points 160 (FIG. 1). That is, the external device 904 can be the autonomous vehicles 161, the user equipment 162, the video capture devices 164, etc. of FIG. 1. The FaaS server 902 sends example function invocations 906 to the example Edge platform 802 and/or the example smart NIC 812. For example, the function invocation 906 includes the function request (e.g., face recognition, face identification, etc.) and corresponding input (e.g., image, etc.). In some examples, the FaaS server 902 sends the function invocations 906 to the Edge platform 802 and/or the smart NIC 812 using a container.

In the illustrated example of FIG. 9, the example Edge platform 802 and/or the example smart MC 812 includes the example CPU(s) 804, the example accelerators 806, 808, the example memory 810, and the example function scheduling controller 814 of FIGS. 8A-8B. For example, the function scheduling controller 814 receives the function invocation 906. In some examples, the function scheduling controller 814 receives example telemetry data 908 from the CPU(s) 804. For example, the telemetry data 908 includes data corresponding to the state of the system and how it is configured (e.g., whether the CPU(s) 804 and/or the accelerators 806, 808 are busy, etc.).

The example function scheduling controller 814 collects function requests for batching. The example function scheduling controller 814 analyzes the function invocation 906 based on the SLA of the function, the telemetry data 908, etc. For example, if the function scheduling controller 814 determines the function invocation 906 can be batched, the function scheduling controller 814 adds the function invocation 906 to an example queue 910. However, if the example function scheduling controller 814 determines the function cannot be batched, the function scheduling controller 814 does not store the function in the queue 910 and sends the function to an example FaaS client 918 for execution. That is, the function scheduling controller 814 refrains from batching the function, bypasses batching the function, etc.

The example queue 910 includes example functions 912, an example batch status 914, and an example SLA 916. In the illustrated example of FIG. 9, the functions 912 stored in the queue 910 include an example function A and an example function B. In examples disclosed herein, the batch status 914 stores a count of batched inputs for the functions 912. For example, the queue 910 stores five inputs for function A and eight inputs for function B. That is, in the illustrated example of FIG. 9, the function scheduling controller 814 received five function A requests and eight function B requests.

In examples disclosed herein, the function scheduling controller 814 orders the functions 912 of the queue 910 based on the SLA 916. In some examples, the SLA 916 corresponds to the latency requirement associated with the functions 912. That is, the latency requirement indicates how long a function can be held without violating the associated SLA 916. For example, function A has a latency requirement of 20 ms. Thus, if function A takes 5 ms to execute, function A can be held for a maximum of 15 ms to not violate the SLA. The example function scheduling controller 814 determines the latency requirement of the function and adds the function to the queue 910 based on the latency requirement. For example, function A has a latency requirement of 20 ms and is ordered before function B, which has a latency requirement of 100 ms. In such examples, function A is sent for execution at an earlier time than function B.

The function scheduling controller 814 sends the functions 912 stored in the queue 910 to the example FaaS client 918. In some examples, the function scheduling controller 814 sends example function invocations with batching 920 to the FaaS client 918 based on the SLA 916. That is, the function invocations with batching 920 include a function request (e.g., the functions 912) with a batch of inputs. For example, the function scheduling controller 814 stores a timestamp of the first instance of the function request of the function 912 in the queue 910. The function scheduling controller 814 tracks the time the functions 912 have been held in the queue 910 for batching. If the example function scheduling controller 814 determines the function stored in the queue 910 has been stored for a time duration that matches the SLA 916 (e.g., the latency requirement), the function scheduling controller 814 sends the function invocation with batching 920 to the FaaS client 918 to satisfy the SLA 916. In some examples, the latency requirement is referred to herein as a waiting threshold. In some examples, the waiting threshold is less than the latency requirement. For example, if the latency requirement for a function is 100 ms and the function takes 10 ms to execute, the waiting threshold can be 90 ms, 80 ms, etc. Additionally or alternatively, the queue 910 can have callback/interrupt functionality. That is, the queue 910 automatically sends the function request to the FaaS client 918 in response to the waiting threshold for the function being satisfied.

The example FaaS client 918 receives the function invocation with batching 920. In examples disclosed herein, the FaaS client 918 executes the function request with the batch of inputs. The FaaS client 918 sends the results to the function scheduling controller 814. In some examples, the function scheduling controller 814 parses and separates the results based on the batch of inputs to send to the FaaS server 902 as separate messages.

FIG. 10 is a block diagram of the example function scheduling controller 814 of FIGS. 8-9. The example function scheduling controller includes an example server interface 1002, an example queue handler 1004, an example function evaluator 1006, an example timing handler 1008, an example client interface 1010, an example function rules database 1012, and an example query API 1014.

The example server interface 1002 accesses function requests. In some examples, the server interface 1002 includes means for communicating with a server (sometimes referred to herein as server communicating means). The example means for communicating with a server is hardware. For example, the server interface 1002 receives the function invocations 906 (FIG. 9) from the FaaS server 902 (FIG. 9). Additionally or alternatively, the example server interface 1002 sends results of the function requests to the FaaS server 902. In some examples, the server interface 1002 can be continuously connected to the FaaS server 902 for communication with the FaaS server 902. In other examples, the server interface 1002 can be periodically or aperiodically connected for periodic or aperiodic communication with the FaaS server 902.

The example queue handler 1004 evaluates the queue (e.g., the queue 910 of FIG. 9). In some examples, the queue handler 1004 includes means for evaluating a queue (sometimes referred to herein as queue evaluating means). The example means for evaluating a queue is hardware. For example, the queue handler 1004 determines whether the function received by the server interface 1002 is stored in the queue. For example, if the function is stored in the queue, the function evaluator 1006 flagged the function for batching at a relatively earlier time. In such examples, the queue handler 1004 stores the input with the function in the queue (e.g., generates a batch of inputs). In some examples, the queue handler 1004 stores the function and the corresponding input in the queue. For example, the queue handler 1004 adds the function to the queue in response to the function being flagged for batching.

In some examples, the example queue handler 1004 stores the function in the queue based on the latency requirement of the function and/or the waiting threshold determined by the timing handler 1008, as further described below. For example, the function scheduling controller 814 receives and stores a function A in the queue for batching with a waiting threshold of 100 ms. The function scheduling controller 814 receives a function B at a time after receiving function A. If function B has a waiting threshold of 50 ms, the queue handler 1004 stores the function B before the function A in the queue (e.g., the function B request will be sent to the FaaS client for execution at a time before the function A request). Thus, the latency requirements of both function A and function B are satisfied.

The example function evaluator 1006 determines whether functions can be batched. That is, the function evaluator 1006 determines whether a function can be stored in the queue to collect additional inputs for the function. In some examples, the function evaluator 1006 includes means for evaluating a function (sometimes referred to herein as function evaluating means). The example means for evaluating a function is hardware. For example, certain AI models and/or functions do not support batching (e.g., the functions cannot be executed on multiple inputs). Thus, the function evaluator 1006 analyzes the type of function and batching capability to determine whether the function supports batching. The example function evaluator 1006 accesses the example function rules database 1012 to determine whether the function supports batching. Additionally or alternatively, the function evaluator 1006 evaluates the target hardware of the function request. In some examples, the target hardware can execute a function on a batch of inputs. However, in some examples, the target hardware executes a batch of inputs sequentially (e.g., the target hardware does not support batching). The function evaluator 1006 accesses the function rules database 1012 to determine whether the target hardware of the function supports batching.

In some examples, the function evaluator 1006 analyzes telemetry data to determine whether the function can be batched. For example, the function evaluator 1006 analyzes the telemetry data 908 (FIG. 9). The telemetry data 908 can indicate the state of the Edge platform 802 and/or the smart NIC 812 of FIG. 8. For example, the telemetry data 908 can indicate a telemetry metric (e.g., the status and/or configuration of the CPU(s) 804, accelerators 806, 808, and the memory 810 of FIG. 8). In some examples, the CPU(s) 804 and/or the accelerators 806, 808 are busy. Thus, batching the function may risk the SLA of the function (e.g., the function may not be executed within the latency requirement, etc.) and the function evaluator 1006 does not flag the function for batching.

Additionally or alternatively, the function evaluator 1006 analyzes the latency requirement and SLA of the function. For example, the function evaluator 1006 accesses the function rules database 1012 to determine the execution times of the function on different resources (e.g., FaaS client 918 of FIG. 9, etc.). For example, the function evaluator 1006 determines whether the execution time of the function on a resource is less than the latency requirement. In some examples, the function evaluator 1006 determines whether the difference between the execution time of the function and the latency requirement is greater than a batching threshold. For example, if the difference is less than the batching threshold, batching the function may not improve computing efficiency. For example, the function may need to be sent for execution before additional function requests are received (e.g., the function scheduling controller 814 does not collect a batch of inputs). If the difference is greater than the batching threshold, the function evaluator 1006 flags the function for batching. In some examples, the batching threshold is 5 ms, 10 ms, etc. Additionally or alternatively, the batching threshold is a threshold deviation from an SLA requirement (e.g., the latency requirement, etc.). For example, the batching threshold is within 5% of the latency requirement, within 10% of the latency requirement, etc.

The example timing handler 1008 determines a time duration the function can be batched. In some examples, the timing handler 1008 includes means for determining a waiting threshold (sometimes referred to herein as a waiting threshold determining means). The example means for determining a waiting threshold is hardware. For example, the timing handler 1008 determines the waiting threshold of the function. That is, the timing handler 1008 determines the amount of time the function can be stored in the queue to collect a batch of inputs without violating the SLA of the function. For example, the timing handler 1008 determines the waiting threshold of the function based on the latency requirement and the execution time of the function.

In some examples, the timing handler 1008 saves a timestamp in the queue corresponding to the time the queue handler 1004 added the function to the queue. The example timing handler 1008 implements a timer to track the amount of time the function has been stored in the queue. In some examples, the timing handler 1008 checks the queue on a periodic basis (e.g., every 5 ms, every 10 ms, etc.) to determine whether the time duration meets the waiting threshold. If the time duration meets the waiting threshold, the function scheduling controller 814 sends the function to the target hardware for execution (e.g., the FaaS client 918 of FIG. 9).

The example client interface 1010 sends function requests and batched inputs to the target hardware. In some examples, the client interface 1010 includes means for communicating with a client device (sometimes referred to herein as client device communicating means). The example means for communicating with a client device is hardware. For example, the client interface 1010 sends the function invocation with batching 920 (FIG. 9) to the FaaS client 918. Additionally or alternatively, the example client interface 1010 receives the function results from the FaaS client 918. In some examples, the client interface 1010 parses the function results to separate the results into individual messages (e.g., one message for each input, etc.). In some examples, the client interface 1010 can be continuously connected to the FaaS client 918 for communication with the FaaS client 918. In other examples, the client interface 1010 can be periodically or aperiodically connected for periodic or aperiodic communication with the FaaS client 918.

The example function rules database 1012 stores function data. For example, the function rules database 1012 stores an indication of whether a function can be batched. Additionally or alternatively, the function rules database 1012 stores an indication of whether target hardware (e.g., the FaaS client 918, etc.) supports batching. In some examples, the function rules database 1012 stores the execution time of the function on the target hardware. The function rules database 1012 of the illustrated example of FIG. 10 is implemented by any memory, storage device, and/or storage disc for storing data such as, for example, flash memory, magnetic media, optical media, solid state memory, hard drive(s), thumb drive(s), etc. Furthermore, the data stored in the example function rules database 1012 may be in any format such as, for example, binary data, comma delimited data, tab delimitated data, structured query language (SQL) structures, etc. While, in the illustrated example of FIG. 10, the function rules database 1012 is illustrated as a single device, the function rules database 1012 and/or any other data storage devices described herein may be implemented by any number and/or type(s) of storage devices.

The example query API 1014 receives queries from a FaaS server (e.g., the FaaS server 902). In some examples, the query API 1014 includes means for receiving queries (sometimes referred to herein as query receiving means). The example means for receiving queries is hardware. For example, FaaS frameworks often include autoscaling mechanisms based on the number of function requests and/or indications of whether function requests have been completed. The example query API 1014 receives queries from the FaaS server 902. The example query API 1014 evaluates the queue (e.g., the queue 910) and sends an indication to the FaaS server 902 of whether the function is being held for batching.

While an example manner of implementing the function scheduling controller 814 of FIGS. 8-9 is illustrated in FIG. 10, one or more of the elements, processes and/or devices illustrated in FIG. 10 may be combined, divided, re-arranged, omitted, eliminated and/or implemented in any other way. Further, the example server interface 1002, the example queue handler 1004, the example function evaluator 1006, the example timing handler 1008, the example client interface 1010, the example function rules database 1012, the example query API 1014 and/or, more generally, the example function scheduling controller 814 of FIG. 10 may be implemented by hardware, software, firmware and/or any combination of hardware, software and/or firmware. Thus, for example, any of the example server interface 1002, the example queue handler 1004, the example function evaluator 1006, the example timing handler 1008, the example client interface 1010, the example function rules database 1012, the example query API 1014 and/or, more generally, the example function scheduling controller 814 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, server interface 1002, the example queue handler 1004, the example function evaluator 1006, the example timing handler 1008, the example client interface 1010, the example function rules database 1012, the example query API 1014 is/are hereby expressly defined to include a non-transitory computer readable storage device or storage disk such as a memory, a digital versatile disk (DVD), a compact disk (CD), a Blu-ray disk, etc. including the software and/or firmware. Further still, the example function scheduling controller 814 of FIG. 10 may include one or more elements, processes and/or devices in addition to, or instead of, those illustrated in FIG. 10, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

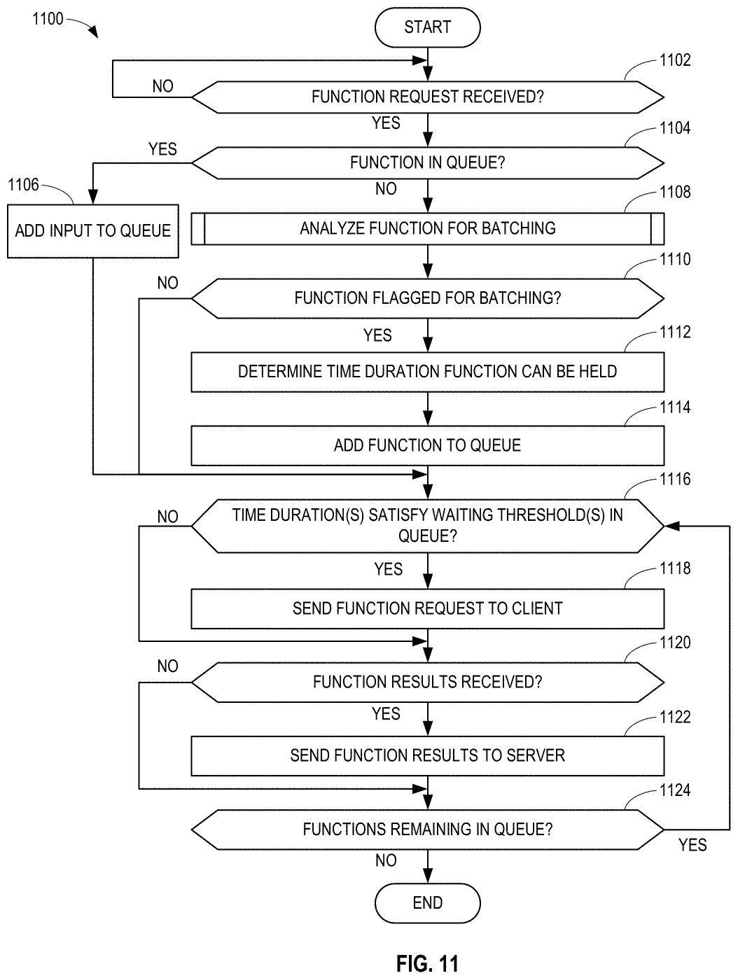

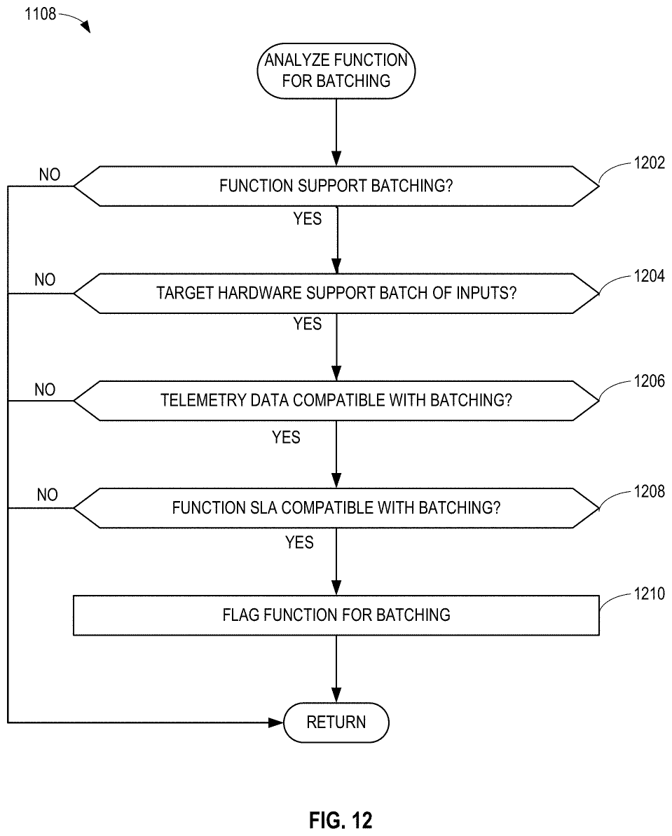

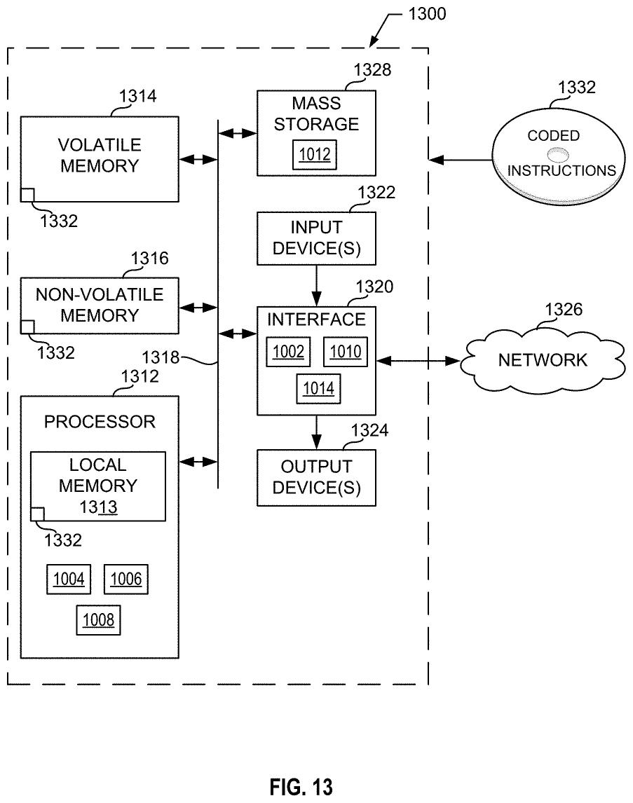

Flowchart representative of example hardware logic, machine readable instructions, hardware implemented state machines, and/or any combination thereof for implementing the function scheduling controller 814 of FIG. 10 are shown in FIGS. 11-12. The machine readable instructions may be one or more executable programs or portion(s) of an executable program for execution by a computer processor and/or processor circuitry, such as the processor 1312 shown in the example processor platform 1300 discussed below in connection with FIG. 13. The program may be embodied in software stored on a non-transitory computer readable storage medium such as a CD-ROM, a floppy disk, a hard drive, a DVD, a Blu-ray disk, or a memory associated with the processor 1312, but the entire program and/or parts thereof could alternatively be executed by a device other than the processor 1312 and/or embodied in firmware or dedicated hardware. Further, although the example program is described with reference to the flowcharts illustrated in FIGS. 11-12, many other methods of implementing the example function scheduling controller 814 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 11-12 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 11 is a flowchart 1100 representative of example machine-readable instructions that may be executed to implement the example function scheduling controller 814 of FIGS. 8-10 to batch functions. The example machine-readable instructions of FIG. 11 begin at block 1102 at which the server interface 1002 (FIG. 10) determines whether a function request is received. For example, the server interface 1002 determines whether the function scheduling controller 814 received the function invocation 906 (FIG. 9) from the FaaS server 902 (FIG. 9). If, at block 1102, the example server interface 1002 determines a function request was not received, instructions return to block 1102. If, at block 1102, the example server interface 1002 determines a function request was received, the example queue handler 1004 (FIG. 10) determines whether the function is stored in the queue (block 1104). For example, the queue handler 1004 analyzes the functions 912 (FIG. 9) stored in the queue 910 (FIG. 9).

If, at block 1104, the example queue handler 1004 determines the function is stored in the queue, the queue handler 1004 adds the input to the queue (block 1106). For example, the queue handler 1004 adds the input to the queue 910 and updates the batch status 914 (FIG. 9). If, at block 1104, the example queue handler 1004 determines the function is not stored in the queue, the example function evaluator 1006 (FIG. 10) analyzes the function for batching (block 1108). For example, the function evaluator 1006 accesses the example function rules database 1012 (FIG. 10) to determine whether the function can be batched, the target hardware can execute the function on a batch of inputs, etc. Further example instructions that may be used to implement block 1108 are described below in connection with FIG. 12.

The example queue handler 1004 determines whether the function is flagged for batching (block 1110). For example, the queue handler 1004 determines whether the function evaluator 1006 flagged the function for batching. If, at block 1110, the queue handler 1004 determines the function is not flagged for batching, instructions proceed to block 1116. If, at block 1110, the queue handler 1004 determines the function is flagged for batching, the example timing handler 1008 (FIG. 10) determines a time duration the function can be held (block 1112). For example, the timing handler 1008 determines the waiting threshold of the function. In some examples, the timing handler 1008 determines the waiting threshold based on the latency requirement of the function and the execution time of the function.

The example queue handler 1004 adds the function to the queue (block 1114). For example, the queue handler 1004 adds the function to the queue 910 based on the waiting threshold. For example, the queue handler 1004 orders the functions stored in the queue in ascending order of waiting thresholds.

The example timing handler 1008 determines whether time duration(s) satisfy waiting threshold(s) in the queue (block 1116). For example, the timing handler 1008 determines whether time durations of the functions stored in the queue satisfy the associated waiting thresholds. If, at block 1116, the timing handler 1008 determines time duration(s) satisfy waiting threshold(s) in the queue, the example client interface 1010 (FIG. 10) sends the function request to the client (block 1118). For example, the client interface 1010 sends the function invocation with batching 920 (FIG. 9) to the FaaS client 918 (FIG. 9).

If, at block 1116, the timing handler 1008 determines time duration(s) do not satisfy the waiting threshold(s) in the queue, the example client interface 1010 determines whether function results are received (block 1120). For example, the client interface 1010 determines whether function results from the FaaS client 918 are received. If, at block 1120, the client interface 1010 determines function results are received, the example server interface 1002 sends the function results to the server (block 1122). For example, the client interface 1010 can parse and separate the function results to generate individual messages corresponding to the function request input. The example server interface 1002 sends the messages to the FaaS server 902.

If, at block 1120, the client interface 1010 determines function results are not received, the example queue handler 1004 determines whether there are functions remaining in the queue (block 1124). For example, the queue handler 1004 determines whether functions are stored in the queue 910 for batching. If, at block 1124, the queue handler 1004 determines functions are stored in the queue, instructions return to block 1116. If, at block 1124, the queue handler 1004 determines functions do not remain in the queue, the instructions of FIG. 11 end.

FIG. 12 is a flowchart 1108 representative of example machine-readable instructions that may be executed to implement the example function scheduling controller 814 of FIGS. 8-10 to evaluate functions. The example machine-readable instructions of FIG. 12 begin at block 1202, at which the example function evaluator 1006 (FIG. 10) determines whether the function supports batching. For example, the function evaluator 1006 determines whether the example function rules database 1012 (FIG. 10) stores an indicator that the function supports batching. If, at block 1202, the function evaluator 1006 determines the function does not support batching, instructions return to block 1110 of FIG. 11.

If, at block 1202, the function evaluator 1006 determines the function does support batching, the function evaluator 1006 determines whether the target hardware of the function supports a batch of inputs (block 1204). For example, the function evaluator 1006 determines whether the example function rules database 1012 stores an indicator that the target hardware corresponding to the function can execute the function on a batch of inputs. If, at block 1204, the function evaluator 1006 determines the target hardware does not support executing the function on a batch of inputs, instructions return to block 1110 of FIG. 11.

If, at block 1204, the function evaluator 1006 determines the target hardware supports executing the function on a batch of inputs, the example function evaluator 1006 determines whether telemetry data is compatible with batching (block 1206). For example, the function evaluator 1006 accesses the telemetry data 908 (FIG. 9) to determine whether the status and/or configuration of the resources of the Edge platform 802 (FIG. 8) and/or the smart NIC 812 (FIG. 8) support batching. If, at block 1206, the function evaluator 1006 determines the telemetry data is not compatible with batching, instructions return to block 1110 of FIG. 11.

If, at block 1206, the function evaluator 1006 determines the telemetry data is compatible with batching, the function evaluator 1006 determines whether the SLA of the function is compatible with batching (block 1208). For example, the function evaluator 1006 determines the execution time of the function on the target hardware and the latency requirements (e.g., stored in the function rules database 1012). For example, if the difference between the execution time and the latency requirement of the function is less than a batching threshold, the function evaluator 1006 determines to not flag the function for batching. If, at block 1208, the function evaluator 1006 determines the function SLA is not compatible with batching, instructions return to block 1110 of FIG. 11.

If, at block 1208, the function evaluator 1006 determines the function SLA is compatible with batching, the function evaluator 1006 flags the function for batching (block 1210). Instructions return to block 1110 of FIG. 11.

FIG. 13 is a block diagram of an example processor platform 1300 structured to execute the instructions of FIGS. 11-12 to implement the function scheduling controller 814 of FIGS. 8-10. The processor platform 1300 can be, for example, a server, a personal computer, a workstation, a self-learning machine (e.g., a neural network), a mobile device (e.g., a cell phone, a smart phone, a tablet such as an iPad), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1300 of the illustrated example includes a processor 1312. The processor 1312 of the illustrated example is hardware. For example, the processor 1312 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example queue handler 1004, the example function evaluator 1006, and the example timing handler 1008.

The processor 1312 of the illustrated example includes a local memory 1313 (e.g., a cache). The processor 1312 of the illustrated example is in communication with a main memory including a volatile memory 1314 and a non-volatile memory 1316 via a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1316 may be implemented by flash memory and/or any other desired type of memory device. Access to the main memory 1314, 1316 is controlled by a memory controller.

The processor platform 1300 of the illustrated example also includes an interface circuit 1320. The interface circuit 1320 may be implemented by any type of interface standard, such as an Ethernet interface, a universal serial bus (USB), a Bluetooth® interface, a near field communication (NFC) interface, and/or a PCI express interface.

In the illustrated example, one or more input devices 1322 are connected to the interface circuit 1320. The input device(s) 1322 permit(s) a user to enter data and/or commands into the processor 1312. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1324 are also connected to the interface circuit 1320 of the illustrated example. The output devices 1324 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1320 of the illustrated example, thus, typically includes a graphics driver card, a graphics driver chip and/or a graphics driver processor.

The interface circuit 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1326. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, redundant array of independent disks (RAID) systems, and digital versatile disk (DVD) drives.

The machine executable instructions 1332 of FIGS. 11-12 may be stored in the mass storage device 1328, in the volatile memory 1314, in the non-volatile memory 1316, and/or on a removable non-transitory computer readable storage medium such as a CD or DVD.

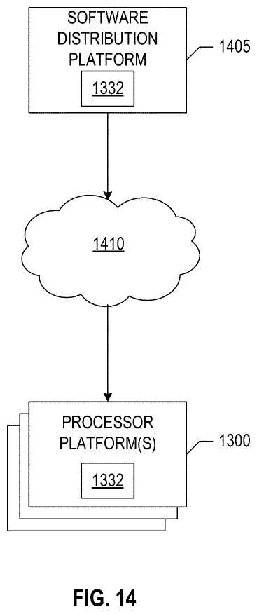

A block diagram illustrating an example software distribution platform 1405 to distribute software such as the example computer readable instructions 1332 of FIG. 13 to third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 1332 of FIG. 13. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the computer readable instructions 1332, which may correspond to the example computer readable instructions of FIGS. 11-12, as described above. The one or more servers of the example software distribution platform 1405 are in communication with a network 1410, which may correspond to any one or more of the Internet and/or any of the example networks 1326 described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 1332 from the software distribution platform 1405. For example, the software, which may correspond to the example computer readable instructions of FIGS. 11-12, may be downloaded to the example processor platform 1300, which is to execute the computer readable instructions 1332 to implement the example function scheduling controller 814. In some example, one or more servers of the software distribution platform 1405 periodically offer, transmit, and/or force updates to the software (e.g., the example computer readable instructions 1332 of FIG. 13) to ensure improvements, patches, updates, etc. are distributed and applied to the software at the end user devices.

From the foregoing, it will be appreciated that example methods, apparatus and articles of manufacture have been disclosed that batch functions. The disclosed methods, apparatus and articles of manufacture improve the efficiency of using a computing device by evaluating whether functions can be batched and, in response to determining a function can be batched, storing the function in a queue to collect a batch of inputs. For example, methods, apparatus and articles of manufacture increase throughput. Additionally or alternatively, example methods, apparatus and articles of manufacture decrease computing time of executing multiple instances of the same function request by requesting the function on a batch of inputs. The disclosed methods, apparatus and articles of manufacture are accordingly directed to one or more improvement(s) in the functioning of a computer.

Example methods, apparatus, systems, and articles of manufacture to batch functions are disclosed herein. Further examples and combinations thereof include the following:

Example 1 includes an apparatus, comprising a function evaluator to, in response to receiving a function request associated with a function and an input, flag the function for batching, a timing handler to determine a waiting threshold associated with the function, a queue handler to store the function, the input, and the waiting threshold in a queue, and a client interface to, in response to a time duration the function is stored in the queue satisfying the waiting threshold, send the function and the input to a client device to increase throughput to the client device.

Example 2 includes the apparatus as defined in example 1, wherein the input is image data.

Example 3 includes the apparatus as defined in example 1, wherein the function evaluator is to determine the function supports batching.

Example 4 includes the apparatus as defined in example 3, wherein the function evaluator is to flag the function for batching.

Example 5 includes the apparatus as defined in example 1, wherein the function evaluator is to flag the function for batching in response to determining the client device supports the function with a batch of inputs.

Example 6 includes the apparatus of example 5, wherein the batch of inputs includes a first image and a second image.

Example 7 includes the apparatus as defined in example 1, wherein the function evaluator is to flag the function for batching in response to determining batching the function satisfies a telemetry metric, the telemetry metric indicating at least one of a state of the client device or a configuration of the client device.

Example 8 includes the apparatus as defined in example 1, wherein the function evaluator is to flag the function for batching in response to determining an execution time of the function satisfies a batching threshold.

Example 9 includes the apparatus as defined in example 8, wherein the batching threshold is within 5 percent of a latency requirement of the function.

Example 10 includes the apparatus as defined in example 1, wherein the function request is a first function request and the input is a first image, and further including a second function request including a second image, the first function request and the second function request corresponding to the function.

Example 11 includes the apparatus as defined in example 10, wherein the queue handler is to add the second image to the function stored in the queue in response to the time duration not satisfying the waiting threshold.

Example 12 includes the apparatus as defined in example 1, wherein the timing handler is to determine the waiting threshold based on at least one of a service level agreement or a latency requirement of the function.

Example 13 includes the apparatus as defined in example 1, wherein the function request is a first function request and the function is a first function, and further including a second function request associated with a second function, the first function different from the second function.

Example 14 includes the apparatus as defined in example 13, wherein the first function is associated with a first service level agreement and a first resource requirement, and the second function is associated with a second service level agreement and a second resource requirement.

Example 15 includes the apparatus as defined in example 13, wherein the client interface is to, in response to the queue handler determining to bypass batching the second function, send the second function to the client device.

Example 16 includes a non-transitory computer readable medium comprising instructions that, when executed, cause at least one processor to, at least in response to receiving a function request associated with a function and an input, flag the function for batching, determine a waiting threshold associated with the function, store the function, the input, and the waiting threshold in a queue, and in response to a time duration the function is stored in the queue satisfying the waiting threshold, send the function and the input to a client device to increase throughput to the client device.

Example 17 includes the non-transitory computer readable medium as defined in example 16, wherein the input is image data.

Example 18 includes the non-transitory computer readable medium as defined in example 16, wherein the instructions, when executed, further cause the at least one processor to determine the function supports batching.

Example 19 includes the non-transitory computer readable medium as defined in example 18, wherein the instructions, when executed, further cause the at least one processor to flag the function for batching.

Example 20 includes the non-transitory computer readable medium as defined in example 16, wherein the instructions, when executed, further cause the at least one processor to flag the function for batching in response to determining the client device supports the function with a batch of inputs.

Example 21 includes the non-transitory computer readable medium as defined in example 20, wherein the batch of inputs includes a first image and a second image.

Example 22 includes the non-transitory computer readable medium as defined in example 16, wherein the instructions, when executed, further cause the at least one processor to flag the function for batching in response to determining batching the function satisfies a telemetry metric, the telemetry metric indicating at least one of a state of the client device or a configuration of a computing device.

Example 23 includes the non-transitory computer readable medium as defined in example 16, wherein the instructions, when executed, further cause the at least one processor to flag the function for batching in response to determining an execution time of the function satisfies a batching threshold.

Example 24 includes the non-transitory computer readable medium as defined in example 23, wherein the batching threshold is within 5 percent of a latency requirement of the function.

Example 25 includes the non-transitory computer readable medium as defined in example 16, wherein the function request is a first function request and the input is a first image, and further including a second function request including a second image, the first function request and the second function request corresponding to the function.

Example 26 includes the non-transitory computer readable medium as defined in example 25, wherein the instructions, when executed, further cause the at least one processor to add the second image to the function stored in the queue in response to the time duration not satisfying the waiting threshold.

Example 27 includes the non-transitory computer readable medium as defined in example 16, wherein the instructions, when executed, further cause the at least one processor to determine the waiting threshold based on at least one of a service level agreement or a latency requirement of the function.

Example 28 includes the non-transitory computer readable medium as defined in example 16, wherein the function request is a first function request and the function is a first function, and further including a second function request associated with a second function, the first function different from the second function.

Example 29 includes the non-transitory computer readable medium as defined in example 28, wherein the first function is associated with a first service level agreement and a first resource requirement, and the second function is associated with a second service level agreement and a second resource requirement.

Example 30 includes the non-transitory computer readable medium as defined in example 16, wherein the instructions, when executed, further cause the at least one processor to, in response to determining to bypass batching the second function, send the second function to the client device.

Example 31 includes a method, comprising in response to receiving a function request associated with a function and an input, flagging the function for batching, determining a waiting threshold associated with the function, storing the function, the input, and the waiting threshold in a queue, and in response to a time duration the function is stored in the queue satisfying the waiting threshold, sending the function and the input to a client device to increase throughput to the client device.

Example 32 includes the method as defined in example 31, wherein the input is image data.

Example 33 includes the method as defined in example 31, further including determining the function supports batching.

Example 34 includes the method as defined in example 33, further including flagging the function for batching.

Example 35 includes the method as defined in example 31, further including flagging the function for batching in response to determining the client device supports the function with a batch of inputs.

Example 36 includes the method as defined in example 35, wherein the batch of inputs includes a first image and a second image.

Example 37 includes the method as defined in example 31, further including flagging the function for batching in response to determining batching the function satisfies a telemetry metric, the telemetry metric indicating at least one of a state of the client device or a configuration of a computing device.

Example 38 includes the method as defined in example 31, further including flagging the function for batching in response to determining an execution time of the function satisfies a batching threshold.

Example 39 includes the method as defined in example 38, wherein the batching threshold is within 5 percent of a latency requirement of the function.

Example 40 includes the method as defined in example 31, wherein the function request is a first function request and the input is a first image, and further including a second function request including a second image, the first function request and the second function request corresponding to the function.

Example 41 includes the method as defined in example 40, further including adding the second image to the function stored in the queue in response to the time duration not satisfying the waiting threshold.

Example 42 includes the method as defined in example 31, further including determining the waiting threshold based on at least one of a service level agreement or a latency requirement of the function.

Example 43 includes the method as defined in example 31, wherein the function request is a first function request and the function is a first function, and further including a second function request associated with a second function, the first function different from the second function.

Example 44 includes the method as defined in example 43, wherein the first function is associated with a first service level agreement and a first resource requirement, and the second function is associated with a second service level agreement and a second resource requirement.

Example 45 includes the method as defined in example 43, further including, in response to determining to bypass batching the second function, sending the second function to the client device.

Example 46 includes an apparatus, comprising means for evaluating a function to, in response to receiving a function request associated with the function and an input, flag the function for batching, means for determining a waiting threshold to determine the waiting threshold associated with the function, means for evaluating a queue to store the function, the input, and the waiting threshold in the queue, and means for communicating with a client device to, in response to a time duration the function is stored in the queue satisfying the waiting threshold, send the function and the input to the client device to increase throughput to the client device.

Example 47 includes the apparatus as defined in example 46, wherein the input is image data.

Example 48 includes the apparatus as defined in example 46, wherein the function evaluating means is to determine the function supports batching.

Example 49 includes the apparatus as defined in example 48, wherein the function evaluating means is to flag the function for batching.

Example 50 includes the apparatus as defined in example 46, wherein the function evaluating means is to flag the function for batching in response to determining the client device supports the function with a batch of inputs.

Example 51 includes the apparatus as defined in example 50, wherein the batch of inputs includes a first image and a second image.

Example 52 includes the apparatus as defined in example 46, wherein the function evaluating means is to flag the function for batching in response to determining batching the function satisfies a telemetry metric, the telemetry metric indicating at least one of a state of the client device or a configuration of the apparatus.

Example 53 includes the apparatus as defined in example 46, wherein the function evaluating means is to flag the function for batching in response to determining an execution time of the function satisfies a batching threshold.

Example 54 includes the apparatus as defined in example 53, wherein the batching threshold is within 5 percent of a latency requirement of the function.

Example 55 includes the apparatus as defined in example 46, wherein the function request is a first function request and the input is a first image, and further including a second function request including a second image, the first function request and the second function request corresponding to the function.

Example 56 includes the apparatus as defined in example 55, wherein the queue evaluating means is to add the second image to the function stored in the queue in response to the time duration not satisfying the waiting threshold.

Example 57 includes the apparatus as defined in example 46, wherein the waiting threshold determining means is to determine the waiting threshold based on at least one of a service level agreement or a latency requirement of the function.

Example 58 includes the apparatus as defined in example 46, wherein the function request is a first function request and the function is a first function, and further including a second function request associated with a second function, the first function different from the second function.

Example 59 includes the apparatus as defined in example 58, wherein the first function is associated with a first service level agreement and a first resource requirement, and the second function is associated with a second service level agreement and a second resource requirement.

Example 60 includes the apparatus as defined in example 58, wherein the client device communicating means is to, in response to the queue evaluating means determining to bypass batching the second function, send the second function to the client device.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. An apparatus, comprising:
a function evaluator to, in response to receiving a function request associated with a function and an input, flag the function for batching;
a timing handler to determine a waiting threshold associated with the function;
a queue handler to store the function, the input, and the waiting threshold in a queue; and
a client interface to, in response to a time duration the function is stored in the queue satisfying the waiting threshold, send the function and the input to a client device to increase throughput to the client device.

2. The apparatus as defined in claim 1, wherein the input is image data.

3. The apparatus as defined in claim 1, wherein the function evaluator is to determine the function supports batching.

4. (canceled)

5. The apparatus as defined in claim 1, wherein the function evaluator is to flag the function for batching in response to determining the client device supports the function with a batch of inputs.

6. (canceled)

7. The apparatus as defined in claim 1, wherein the function evaluator is to flag the function for batching in response to determining batching the function satisfies a telemetry metric, the telemetry metric indicating at least one of a state of the client device or a configuration of the client device.

8. The apparatus as defined in claim 1, wherein the function evaluator is to flag the function for batching in response to determining an execution time of the function satisfies a batching threshold.

9. (canceled)

10. The apparatus as defined in claim 1, wherein the function request is a first function request and the input is a first image, and further including a second function request including a second image, the first function request and the second function request corresponding to the function.

11. The apparatus as defined in claim 10, wherein the queue handler is to add the second image to the function stored in the queue in response to the time duration not satisfying the waiting threshold.

12. (canceled)

13. The apparatus as defined in claim 1, wherein the function request is a first function request and the function is a first function, and further including a second function request associated with a second function, the first function different from the second function.

14. (canceled)

15. The apparatus as defined in claim 13, wherein the client interface is to, in response to the queue handler determining to bypass batching the second function, send the second function to the client device.

16. A non-transitory computer readable medium comprising instructions that, when executed, cause at least one processor to, at least:
in response to receiving a function request associated with a function and an input, flag the function for batching;
determine a waiting threshold associated with the function;
store the function, the input, and the waiting threshold in a queue; and
in response to a time duration the function is stored in the queue satisfying the waiting threshold, send the function and the input to a client device to increase throughput to the client device.

17. (canceled)

18. The non-transitory computer readable medium as defined in claim 16, wherein the instructions, when executed, further cause the at least one processor to determine the function supports batching.

19.-21. (canceled)

22. The non-transitory computer readable medium as defined in claim 16, wherein the instructions, when executed, further cause the at least one processor to flag the function for batching in response to determining batching the function satisfies a telemetry metric, the telemetry metric indicating at least one of a state of the client device or a configuration of a computing device.

23. The non-transitory computer readable medium as defined in claim 16, wherein the instructions, when executed, further cause the at least one processor to flag the function for batching in response to determining an execution time of the function satisfies a batching threshold.

24. (canceled)

25. The non-transitory computer readable medium as defined in claim 16, wherein the function request is a first function request and the input is a first image, and further including a second function request including a second image, the first function request and the second function request corresponding to the function.

26. The non-transitory computer readable medium as defined in claim 25, wherein the instructions, when executed, further cause the at least one processor to add the second image to the function stored in the queue in response to the time duration not satisfying the waiting threshold.

27. (canceled)

28. The non-transitory computer readable medium as defined in claim 16, wherein the function request is a first function request and the function is a first function, and further including a second function request associated with a second function, the first function different from the second function.

29. (canceled)

30. The non-transitory computer readable medium as defined in claim 28, wherein the instructions, when executed, further cause the at least one processor to, in response to determining to bypass batching the second function, send the second function to the client device.

31.-45. (canceled)

46. An apparatus, comprising:
means for evaluating a function to, in response to receiving a function request associated with the function and an input, flag the function for batching;
means for determining a waiting threshold to determine the waiting threshold associated with the function;
means for evaluating a queue to store the function, the input, and the waiting threshold in the queue; and
means for communicating with a client device to, in response to a time duration the function is stored in the queue satisfying the waiting threshold, send the function and the input to the client device to increase throughput to the client device.

47.-51. (canceled)

52. The apparatus as defined in claim 46, wherein the function evaluating means is to flag the function for batching in response to determining batching the function satisfies a telemetry metric, the telemetry metric indicating at least one of a state of the client device or a configuration of the apparatus.

53. The apparatus as defined in claim 46, wherein the function evaluating means is to flag the function for batching in response to determining an execution time of the function satisfies a batching threshold.

54. (canceled)

55. The apparatus as defined in claim 46, wherein the function request is a first function request and the input is a first image, and further including a second function request including a second image, the first function request and the second function request corresponding to the function.

56. The apparatus as defined in claim 55, wherein the queue evaluating means is to add the second image to the function stored in the queue in response to the time duration not satisfying the waiting threshold.

57. (canceled)

58. The apparatus as defined in claim 46, wherein the function request is a first function request and the function is a first function, and further including a second function request associated with a second function, the first function different from the second function.

59. (canceled)

60. The apparatus as defined in claim 58, wherein the client device communicating means is to, in response to the queue evaluating means determining to bypass batching the second function, send the second function to the client device.
